(19) United States
(12) Patent Application Publication
(10) Pub. No.: US 2026/0296318 A1
(43) Pub. Date: Oct. 1, 2026

(54) Vehicle Rear Seat Monitoring Device

(71) Applicant: Jet Optoelectronics Co., Ltd., Taipei City (TW)

(72) Inventors: Jen-Huang Tsai, Taipei City (TW); Chun-Jen Lee, Taipei City (TW); Ming-Te Hung, Taipei City (TW)

(21) Appl. No.: 19/237,312

(22) Filed: Jun. 13, 2025

(30) Foreign Application Priority Data
Mar. 28, 2025 (TW) 114112143

(51) Int. Cl. B60R 1/29; B60Q 3/76

(52) U.S. Cl. CPC B60R 1/29; B60Q 3/76

(57) ABSTRACT

A vehicle rear seat monitoring device is provided. The vehicle rear seat monitoring device includes a camera, a lighting apparatus, and a first wireless transmitter. The camera and the lighting apparatus are electrically connected to the first wireless transmitter, and the lighting apparatus is also electrically connected to the camera. The vehicle rear seat monitoring device can transmit images to a vehicle screen or other portable devices via the first wireless transmitter, allowing monitoring of the rear seat passengers' status or recording of the in-vehicle situation.

### CROSS-REFERENCE TO RELATED APPLICATION

The present application claims priority to, and the benefit of, Taiwan Patent Application No. 114112143, filed on Mar. 28, 2025, in the Taiwan Intellectual Property Office, the disclosure of which is incorporated by reference herein in its entirety.

### BACKGROUND OF THE INVENTION

### 1. Field of the Invention

The present invention relates to a vehicle rear seat monitoring device, and more particularly to a vehicle rear seat monitoring device installed at a reading light (also referred to as an illumination light) position above a rear seat door.

### 2. Description of the Related Art

The vehicle monitoring device are used for safety surveillance or passenger protection, for example, to interact with children seated in the rear seat or to record in-vehicle situations, providing evidence in the event of an accident or crime. In addition to ensuring passenger safety, it is also able to provide video evidences in disputes.

Conventional vehicle monitoring devices are generally external units that require additional wiring for power supply and image signal transmission. This results in a less aesthetically pleasing vehicle interior and increases the risk of passengers accidentally pulling on the wires, leading to inconvenience in use. Furthermore, because the conventional vehicle monitoring devices are externally installed, their bodies occupy interior space and affect passenger comfort.

In addition, when a child safety seat is placed on the rear seat, for safety reasons, it is typically installed in a rear-facing position, meaning the seat faces the rear of the vehicle. Adults in the front seats cannot see the child's face through the in-vehicle rearview mirror, making it difficult to monitor the child's condition in real time.

Therefore, it is necessary to develop an in-vehicle monitoring device that does not require additional wiring and is able to be integrated into the vehicle interior, particularly a vehicle monitoring device capable of monitoring rear seat passengers.

### SUMMARY OF THE INVENTION

In view of the foregoing issues, the primary objective of the present invention is to provide a vehicle rear seat monitoring device.

To achieve the above objective, the present invention provides a vehicle rear seat monitoring device. The vehicle rear seat monitoring device includes a camera, a lighting apparatus, and a first wireless transmitter. The camera and the lighting apparatus are electrically connected to the first wireless transmitter, and the lighting apparatus is also electrically connected to the camera. In addition, arrangement positions of the camera, the lighting apparatus, and the first wireless transmitter within the vehicle rear seat monitoring device are not particularly limited, as long as the functional operation of each component is not adversely affected.

The camera may include a lens, an image sensor, and an image processor, and the image sensor may be coupled to the lens and electrically connected to the image processor, respectively.

When the vehicle rear seat monitoring device is in operation, the image sensor may be configured to capture images through the lens to generate an image signal, and transmit the image signal to the image processor to generate a processed image signal. Finally, the processed image signal may be transmitted through the first wireless transmitter to a vehicle screen or other portable device for monitoring a status of a rear seat passenger or recording the in-vehicle situation.

Preferably, the vehicle rear seat monitoring device may further include a microphone and a speaker. The microphone and the speaker may be electrically connected to the first wireless transmitter, and may also be electrically connected to the camera.

By further providing the microphone in the vehicle rear seat monitoring device, the device is able to not only provide video footage of the rear seat but also simultaneously capture audio through the microphone during recording. When incidents or disputes occur, a combination of the video and the audio would enable a clearer understanding and recording of the situation at that time.

Moreover, by further providing the speaker in the vehicle rear seat monitoring device, the vehicle rear seat monitoring device may be able to play sounds through the speaker, which allows the front seat driver, front seat passengers, or even individuals outside the vehicle cabin, when finding the rear seat passengers having an incident that needs to be cautioned via the vehicle screen or other portable devices, to emit sound alerts or confirm the status of the rear seat passengers in case of any abnormal situation.

The vehicle screen may be a screen of a car dashboard, or a screen of other vehicle control panels or vehicle entertainment devices, but is not limited thereto. The portable device may be a mobile phone, a tablet, a laptop computer, a smartwatch, or any other device equipped with a display screen, but is not limited thereto.

Preferably, the lighting apparatus may be used together with the camera or used independently. When the lighting apparatus is used together with the camera, the image processor is configured to issue an identification signal to control the lighting apparatus to serve as supplementary lighting. Furthermore, when an abnormal situation involving a rear seat passenger is detected, an operation command may be issued via the vehicle screen or other portable devices to the first wireless transmitter to control the lighting apparatus, so as to increase a brightness thereof or to flash for alerting the rear seat passenger. When the lighting apparatus is used independently, the lighting apparatus may function as a general reading light or an interior illumination light.

Preferably, the vehicle rear seat monitoring device may be installed at the position of the traditional reading light above the rear seat door to replace the traditional reading light. As a result, no additional wiring would be needed to supply power to the vehicle rear seat monitoring device; instead, the in-vehicle power source originally provided for the traditional reading light may be used directly. Moreover, since the lighting apparatus is provided on the vehicle rear seat monitoring device, it still retains the function of a traditional reading light. On the other hand, because the vehicle rear seat monitoring device is installed at the position of the traditional reading light above the rear seat door, even if a child safety seat is placed in a rear-facing position on the rear seat, the lens may still clearly capture the child's face within its field of view.

On the other hand, the vehicle screen may include a first display module and a second wireless transmitter. The second wireless transmitter may be electrically connected to the first display module and may be configured to receive the processed image signal transmitted by the first wireless transmitter of the vehicle rear seat monitoring device, and to transmit the processed image signal to the first display module for displaying the rear seat images on the vehicle screen.

On another aspect, the portable device may include a second display module and a third wireless transmitter. The third wireless transmitter may be electrically connected to the second display module and may be configured to receive the processed image signal transmitted by the first wireless transmitter of the vehicle rear seat monitoring device, and to transmit the processed image signal to the second display module for displaying the rear seat images on the portable device.

The technical features of the present invention will be described in detail below with specific embodiments and accompanying drawings, such that a person skilled in the art can easily understand the purpose, technical features and advantages of the present invention.

### BRIEF DESCRIPTION OF THE DRAWINGS

In order to more clearly illustrate the technical solutions of the embodiments of the present invention, the drawings required for use in the description of the embodiments of the present invention will be briefly introduced below. Obviously, the drawings described below are only some embodiments of the present invention. For those with ordinary knowledge in the technical field to which the present invention belongs, other drawings can be obtained based on these drawings.

FIG. 1 is a block diagram illustrating a vehicle rear seat monitoring device of the present invention;

FIG. 2 is a block diagram illustrating the vehicle rear seat monitoring device of the present invention, further including a microphone and a speaker;

FIG. 3 is a block diagram illustrating the vehicle rear seat monitoring device of the present invention, which is connected to an in-vehicle power source and wirelessly connected to a vehicle screen for use; and

FIG. 4 is a block diagram illustrating the vehicle rear seat monitoring device of the present invention, which is connected to an in-vehicle power source and wirelessly connected to a portable device for use.

### DETAILED DESCRIPTION OF THE PREFERRED EMBODIMENTS

In order to help the examiner understand the technical features, contents and advantages of the present invention and the effects that can be achieved, the present invention is described in detail as follows with the accompanying drawings and in the form of embodiments. The drawings used therein are only for illustration and auxiliary description, and may not be the true proportions and precise configurations after the implementation of the present invention. Therefore, it should not be interpreted based on the proportions and configurations of the attached drawings to limit the scope of rights of the present invention in actual implementation.

Unless otherwise defined, all terms (including technical and scientific terms) used herein have the same meaning as commonly understood by one of ordinary skill in the art to which this invention belongs. It will be further understood that those terms as defined in commonly used dictionaries should be interpreted as having a meaning consistent with their meaning in the context of the relevant art and the present invention, and will not be interpreted as an idealized or overly formal meaning unless expressly so defined herein.

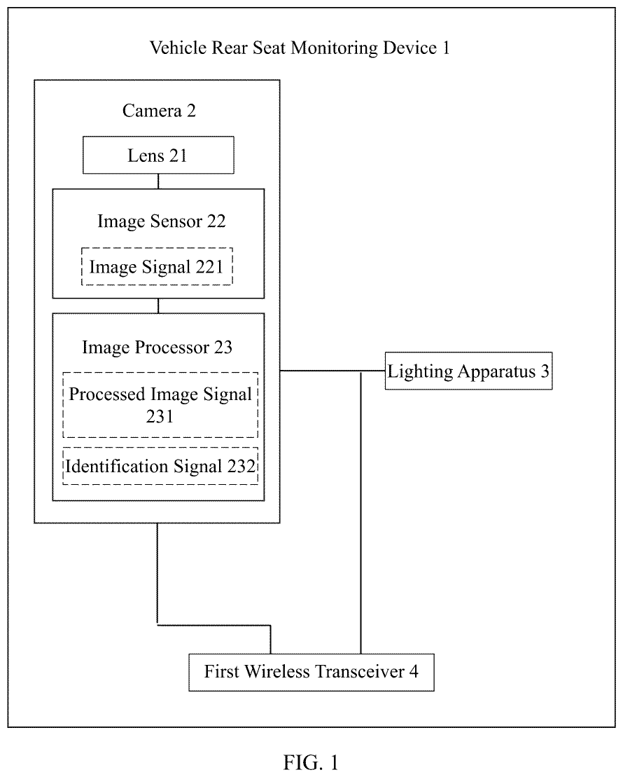

Referring to FIG. 1, which is a block diagram illustrating a vehicle rear seat monitoring device of the present invention. The vehicle rear seat monitoring device 1 includes a camera 2, a lighting apparatus 3, and a first wireless transmitter 4. The camera 2 and the lighting apparatus 3 are electrically connected to the first wireless transmitter 4, and the lighting apparatus 3 is also electrically connected to the camera 2. In addition, arrangement positions of the components such as the camera 2, the lighting apparatus 3, and the first wireless transmitter 4 within the vehicle rear seat monitoring device 1 are not particularly limited, as long as the functional operation of each component is not adversely affected.

The camera 2 may include a lens 21, an image sensor 22, and an image processor 23. The image sensor 22 may be coupled to the lens 21 and may be electrically connected to the image processor 23.

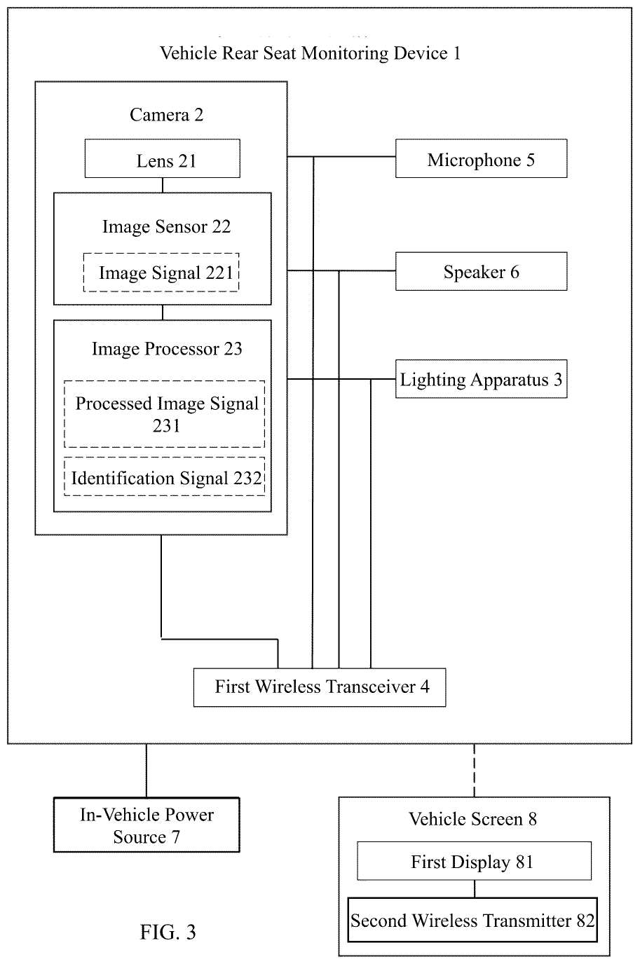

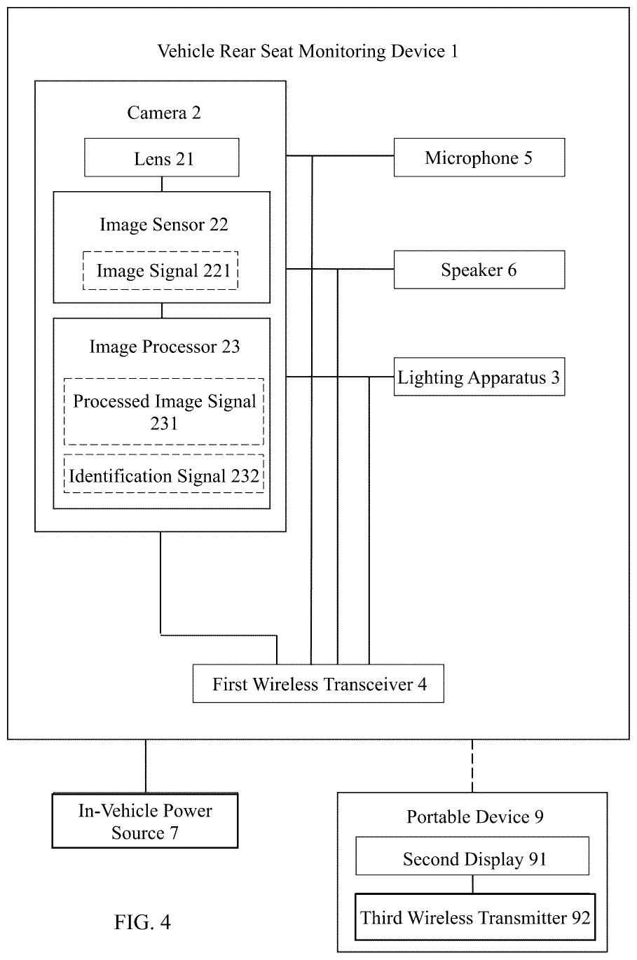

When the vehicle rear seat monitoring device 1 is in operation, the image sensor 22 would capture images taken by the lens 21 to generate an image signal 221, and transmit the image signal 221 to the image processor 23 to generate a processed image signal 231. Finally, the processed image signal 231 may be transmitted via the first wireless transmitter 4 to a vehicle screen 8 or another portable device 9 (see also FIGS. 3 and 4), for monitoring the status of rear seat passengers or recording the in-vehicle situation.

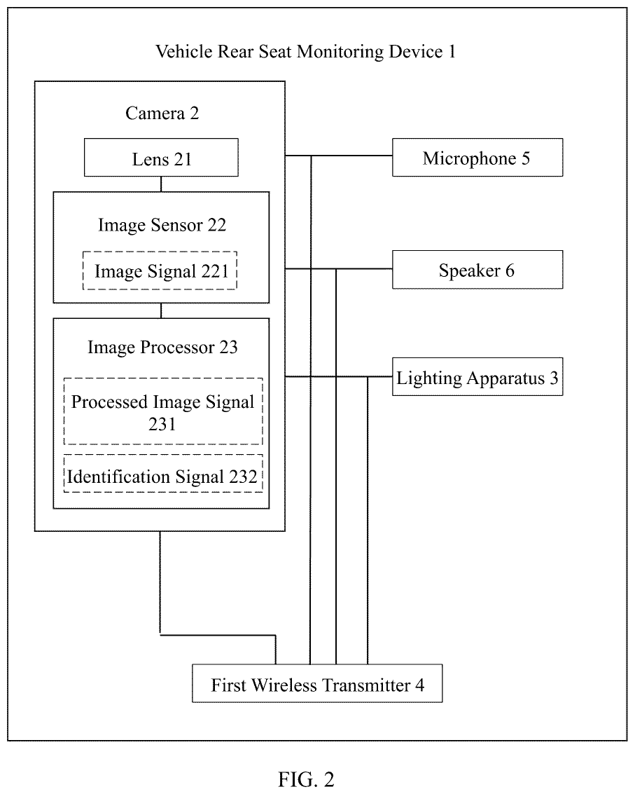

Referring to FIG. 2, which is a block diagram illustrating the vehicle rear seat monitoring device of the present invention, further including a microphone and a speaker. Preferably, the vehicle rear seat monitoring device 1 may further include a microphone 5 and a speaker 6. The microphone 5 and the speaker 6 may be electrically connected to the first wireless transmitter 4, and may also be electrically connected to the camera 2, respectively.

By further providing the microphone 5 in the vehicle rear seat monitoring device 1, the device not only provides video footage of the rear seat but also captures audio during recording through the microphone 5. When incidents or disputes arise, the combination of video and audio would enable a clearer understanding and recording of the situation at that moment.

Moreover, by further providing the speaker 6 in the vehicle rear seat monitoring device 1, the vehicle rear seat monitoring device 1 may be able to play sounds through the speaker 6, which allows the front seat driver, front seat passengers, or even individuals outside the vehicle cabin, when finding the rear seat passengers having an incident that needs to be cautioned via the vehicle screen 8 or other portable devices 9, to emit sound alerts or confirm the status of the rear seat passengers in case of any abnormal situation.

The vehicle screen 8 may be a screen of a car dashboard, or a screen of other vehicle control panels or vehicle entertainment devices, but is not limited thereto. The portable device 9 may be a mobile phone, a tablet, a laptop computer, a smartwatch, or any other device equipped with a display screen, but is not limited thereto.

Preferably, the lighting apparatus 3 may be configured to be used together with the camera 2 or used independently. When the lighting apparatus 3 is used together with the camera 2, the image processor 23 is configured to issue an identification signal 232 to control the lighting apparatus 3 to serve as supplementary lighting. Furthermore, when an abnormal situation involving a rear seat passenger is detected, an operation command may be issued via the vehicle screen 8 or other portable devices 9 to the first wireless transmitter 4 to control the lighting apparatus 3, so as to increase a brightness thereof or to flash for alerting the rear seat passenger. When the lighting apparatus 3 is used independently, the lighting apparatus 3 may function as a general reading light or an interior illumination light.

Preferably, the vehicle rear seat monitoring device 1 is installed at the position of the traditional reading light above the rear seat door to replace the traditional reading light. As such, there is no need to install additional wiring to supply power to the vehicle rear seat monitoring device 1, as it is able to directly utilize the in-vehicle power source 7 originally provided for the traditional reading light (see also FIGS. 3 and 4). Moreover, since the lighting apparatus 3 is provided on the vehicle rear seat monitoring device 1, it may retain the same function as a traditional reading light. On the other hand, because the vehicle rear seat monitoring device 1 is installed at the position of the traditional reading light above the rear seat door, even when a child safety seat is rear-facing in the rear seat, the lens 21 may still clearly capture the child's face within its field of view.

Referring to FIG. 3, which is a block diagram illustrating the vehicle rear seat monitoring device of the present invention, connected to an in-vehicle power source and wirelessly connected to a vehicle screen for use. When using the vehicle rear seat monitoring device 1, it may be powered by the in-vehicle power source 7. The vehicle screen 8 may include a first display module 81 and a second wireless transmitter 82. The second wireless transmitter 82 may be electrically connected to the first display module 81 and may be configured to receive the processed image signal 231 transmitted from the first wireless transmitter 4 of the vehicle rear seat monitoring device 1, and to transmit the processed image signal 231 to the first display module 81 for displaying the rear seat images on the vehicle screen 8.

Referring to FIG. 4, which is a block diagram illustrating the vehicle rear seat monitoring device of the present invention, connected to an in-vehicle power source and wirelessly connected to a portable device for use. When using the vehicle rear seat monitoring device 1, it may be powered by the in-vehicle power source 7. The portable device 9 may include a second display module 91 and a third wireless transmitter 92. The third wireless transmitter 92 may be electrically connected to the second display module 91 and may be configured to receive the processed image signal 231 transmitted from the first wireless transmitter 4 of the vehicle rear seat monitoring device 1, and to transmit the processed image signal 231 to the second display module 91 for displaying the rear seat images on the portable device 9.

In conclusion, compared to conventional external vehicle monitoring devices that require additional wiring, the vehicle rear seat monitoring device provided by the present invention is able to be installed at the position of the traditional reading light above the rear seat door. This design not only allows the direct use of the in-vehicle power source originally supplied to the traditional reading light without the need for additional wiring, but also avoids occupying cabin space since the device body is embedded within the original reading light location. Furthermore, the installation position enables the lens to clearly capture the faces of rear seat passengers without obstruction. In addition, since the vehicle rear seat monitoring device of the present invention utilizes a wireless transmitter to transmit the rear seat images, any display device or apparatus capable of receiving wireless signals may easily obtain the rear seat images, eliminating the need for additional transmission cables to connect the vehicle rear seat monitoring device to the display equipment. This significantly enhances the convenience of use.

The embodiments of the invention covered by this patent are defined by the scope of the patent application, not the content of this invention. This disclosure is a high-level overview of various aspects of the invention and introduces some of the concepts further described in the following detailed description. This disclosure is not intended to identify key or essential features of the claimed subject matter, nor is it intended to be used alone to define the scope of the claimed subject matter. The subject matter should be understood by reference to the entire specification, any or all drawings and appropriate portions of each claim.

1. A vehicle rear seat monitoring device, comprising:
a camera;
a lighting apparatus; and
a first wireless transmitter, wherein
the camera and the lighting apparatus are electrically connected to the first wireless transmitter;
the lighting apparatus is electrically connected to the camera; and
the camera includes a lens, an image sensor, and an image processor, and the image sensor is coupled to the lens and electrically connected to the image processor,
wherein the vehicle rear seat monitoring device is installed at a reading light position above a rear door of the vehicle and configured to replace a reading light designed to be installed at the reading light position.

2. The vehicle rear seat monitoring device according to claim 1, wherein
the image sensor is configured to capture an image through the lens to generate an image signal, and transmit the image signal to the image processor; and
the image signal is converted into a processed image signal by the image processor, and the processed image signal is transmitted to a vehicle screen or a portable device via wireless transmission through the first wireless transmitter.

3. The vehicle rear seat monitoring device according to claim 2, wherein the vehicle screen is a screen of a car dashboard, a screen of a vehicle control panel, or a screen of a vehicle entertainment device.

4. The vehicle rear seat monitoring device according to claim 2, wherein the portable device is a mobile phone, a tablet, a laptop computer, or a smartwatch.

5. (canceled)

6. The vehicle rear seat monitoring device according to claim 1, wherein the vehicle rear seat monitoring device is powered directly by an in-vehicle power source originally connected to the reading light.

7. The vehicle rear seat monitoring device according to claim 1, wherein the lighting apparatus is configured to be used together with the camera in which the image sensor is configured to transmit an identification signal to control the lighting apparatus to provide supplementary lighting.

8. The vehicle rear seat monitoring device according to claim 1, wherein the lighting apparatus is configured to independently provide an original function of the reading light.

9. The vehicle rear seat monitoring device according to claim 1, wherein the vehicle rear seat monitoring device further comprises a microphone, which is electrically connected to the first wireless transmitter and the camera, and is configured to simultaneously receive sound while the camera is capturing images.

10. The vehicle rear seat monitoring device according to claim 1, wherein the vehicle rear seat monitoring device further comprises a speaker, which is electrically connected to the first wireless transmitter and the camera, and is configured to emit sound to remind or confirm a status of a rear seat passenger.
